(19) United States
(12) Patent Application Publication
(10) Pub. No.: US 2025/0378612 A1
(43) Pub. Date: Dec. 11, 2025

(54) VIDEO PROCESSING METHOD, DEVICE AND STORAGE MEDIUM

(71) Applicants: Beijing Zitiao Network Technology Co., Ltd., Haidian District (CN); Lemon Inc., Grand Cayman (KY)

(72) Inventors: Weibo GONG, Beijing (CN); Xiaojie JIN, Los Angeles, CA (US)

(21) Appl. No.: 19/229,852

(22) Filed: Jun. 5, 2025

(30) Foreign Application Priority Data
Jun. 6, 2024 (CN) 202410732860.8

(51) Int. Cl. G06T 13/20; G06F 40/30; G06V 10/62; G06V 10/77; G06V 20/40

(52) U.S. Cl. CPC G06T 13/20; G06V 10/62; G06V 10/7715; G06V 20/46; G06F 40/30

(57) ABSTRACT

Embodiments of the present disclosure provide a video processing method, device and storage medium. The method includes: extracting text content, audio content and a video frame sequence included in an original video; encoding the text content, the audio content and the video frame sequence to obtain text feature information, audio feature information and video frame feature information, respectively; performing effect enhancement inference on the original video to obtain effect enhancement description information according to the text feature information, the audio feature information and the video frame feature information, where the effect enhancement description information includes an effect enhancement position description and a corresponding effect enhancement element description; and performing effect rendering on the original video using the effect enhancement description information to obtain an effect enhanced video of the original video.

### CROSS-REFERENCE TO RELATED APPLICATION

This application claims the priority to and benefits of the Chinese Patent Application, No. 202410732860.8, which was filed on Jun. 6, 2024. All the aforementioned patent applications are hereby incorporated by reference in their entireties.

### TECHNICAL FIELD

Embodiments of the present disclosure relate to a field of image processing technology, and in particular to a video processing method, apparatus, device and storage medium.

### BACKGROUND

At present, video packaging may be achieved by performing effect processing on an original video. However, an existing processing method for video effect processing is mainly implemented by manually adding an effect, which is complicated and has a single effect, such as adding a sticker, a single music sound effect, etc. An existing video effect processing cannot guarantee that a packaged video will present a better effect enhancement outcome, and the process is complicated, which affects the visual and auditory experience that the packaged video may bring about.

### SUMMARY

The present disclosure provides a video processing method, apparatus, device and storage medium, to improve an effect enhancement outcome of a video.

At least one embodiment of the present disclosure provides a video processing method, and the video processing method includes:
extracting text content, audio content and a video frame sequence included in an original video;
encoding the text content, the audio content and the video frame sequence to obtain text feature information, audio feature information and video frame feature information, respectively;

performing effect enhancement inference on the original video to obtain effect enhancement description information according to the text feature information, the audio feature information and the video frame feature information, where the effect enhancement description information includes an effect enhancement position description and a corresponding effect enhancement element description; and
performing effect rendering on the original video using the effect enhancement description information to obtain an effect enhanced video of the original video.

At least one embodiment of the present disclosure provides a video processing apparatus, and the video processing apparatus includes:
an information extracting module, which is configured to extract text content, audio content and a video frame sequence included in an original video;
an encoding processing module, which is configured to encode the text content, the audio content and the video frame sequence to obtain text feature information, audio feature information and video frame feature information, respectively;
an information determining module, which is configured to perform effect enhancement inference on the original video to obtain effect enhancement description information according to the text feature information, the audio feature information and the video frame feature information, where the effect enhancement description information includes an effect enhancement position description and a corresponding effect enhancement element description; and
an effect rendering module, which is configured to perform effect rendering on the original video using the effect enhancement description information to obtain an effect enhanced video of the original video.

At least one embodiment of the present disclosure provides an electronic device, and the electronic device includes:
at least one processor; and
a memory configured to store one or more programs, where
the one or more programs, when executed by the at least one processor, cause the at least one processor to implement the video processing method according to any embodiment of the present disclosure.

At least one embodiment of the present disclosure provides a non-transitory computer-readable storage medium having a computer program stored thereon, and the program, when executed by a processor, implements the video processing method according to any embodiment of the present disclosure.

At least one embodiment of the present disclosure provides a computer program product including a computer program, and the computer program when executed by a processor, implementing the video processing method according to any embodiment of the present disclosure.

In the technical solutions of embodiments of the present disclosure, by providing a video processing method, text content, audio content and a video frame sequence included in an original video may be first extracted; and then the text content, the audio content and the video frame sequence are encoded to obtain corresponding text feature information, audio feature information and video frame feature information respectively, and next effect enhancement inference may be performed on the original video based on various feature information obtained to obtain effect enhancement description information, and finally effect rendering may be performed on the original video using the effect enhancement description information, to obtain an effect enhanced video of the original video.

### BRIEF DESCRIPTION OF DRAWINGS

The above and other features, advantages and aspects of the embodiments of the present disclosure will become more apparent in conjunction with the drawings and with reference to the following specific implementation methods. Throughout the accompanying drawings, the same or similar reference numerals represent the same or similar elements. It should be understood that the drawings are schematic, and the components and elements are not necessarily drawn to scale.

FIG. 1a is a schematic flow diagram of a video processing method provided by embodiment of the present disclosure;

FIG. 1b is a schematic diagram of a sample text content in a video processing method provided by embodiments of the present disclosure;

FIG. 1c is a schematic diagram of an expected effect description information in a video processing method provided by embodiments of the present disclosure;

FIG. 2 is a schematic diagram of an example implementation for a video processing method provided by embodiments of the present disclosure;

FIG. 3 is a structural schematic diagram of a video processing apparatus provided by embodiments of the present disclosure; and

FIG. 4 is a structural schematic diagram of an electronic device provided by embodiments of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that the various steps described in the method implementations of the present disclosure may be performed in different orders, and/or performed in parallel. Furthermore, the method implementations may include additional steps and/or omit performing the illustrated steps. The protection scope of the present disclosure is not limited in this respect.

The term “include/include” and variations thereof used herein are open-ended inclusions, namely, “include/include but not limited to”. The term “based on” is “at least partially based on”. The term “an embodiment” means “at least one embodiment”. The term “another embodiment” means “at least one additional embodiment”. The term “some embodiments” means “at least some embodiments”. Relevant definitions of other terms will be given in the description below.

It should be noted that concepts such as “first” and “second” mentioned in the present disclosure are only used to distinguish between different apparatuses, modules, or units, and are not used to limit a sequence of functions performed by these apparatuses, modules, or units or interdependence between the functions.

It should be noted that modifications of “one” and “a plurality of” mentioned in the present disclosure are illustrative rather than restrictive. Those skilled in the art should understand that unless otherwise clearly indicated in the context, they should be understood as “one or more”.

The names of messages or information exchanged between a plurality of apparatuses in the implementations of the present disclosure are only for illustrative purposes, and are not intended to limit the scope of the messages or information.

It should be understood that before using the technical solutions disclosed in the embodiments of the present disclosure, the user should be informed of the type of personal information involved in the present disclosure, the scope of use, the usage scenario, and the like through an appropriate manner in accordance with relevant laws and regulations, and the user's authorization should be obtained.

For example, when the receiving of the active request from the user is responded to, prompt information is sent to the user, so as to explicitly prompt the user that the operation requested to be performed by the user will require the acquisition and use of the user's personal information. Thus, the user can independently choose whether to provide the personal information to the software or hardware such as the electronic device, the application, the server, or the storage medium that performs the operation of the technical solution of the present disclosure, according to the prompt information.

As an optional but non-limiting implementation, for example, the manner of sending the prompt information to the user in response to the receiving of the active request from the user may be a manner of a pop-up window, and the prompt information may be presented in text in the pop-up window. In addition, the pop-up window may also include a selection control for the user to select “agree” or “disagree” to provide the personal information to the electronic device.

It can be understood that the above process of notifying and acquiring the user's authorization is only illustrative, and does not constitute a limitation on the implementations of the present disclosure. Other manners that meet the requirements of relevant laws and regulations may also be applied to the implementations of the present disclosure.

It can be understood that the data involved in the technical solution (including but not limited to the data itself, the acquisition or use of the data) should comply with the requirements of corresponding laws and regulations and related provisions.

It should be noted that when a user has the need to add effects to a video, the effects may be added or edited manually through some effect editing software, but such manner requires the user to have a certain basis in effect editing, which is not friendly to non-professionals. Although there are some effect editing software that may be operated by non-professionals, it also takes users a lot of time and energy to produce effect enhanced videos with good outcome.

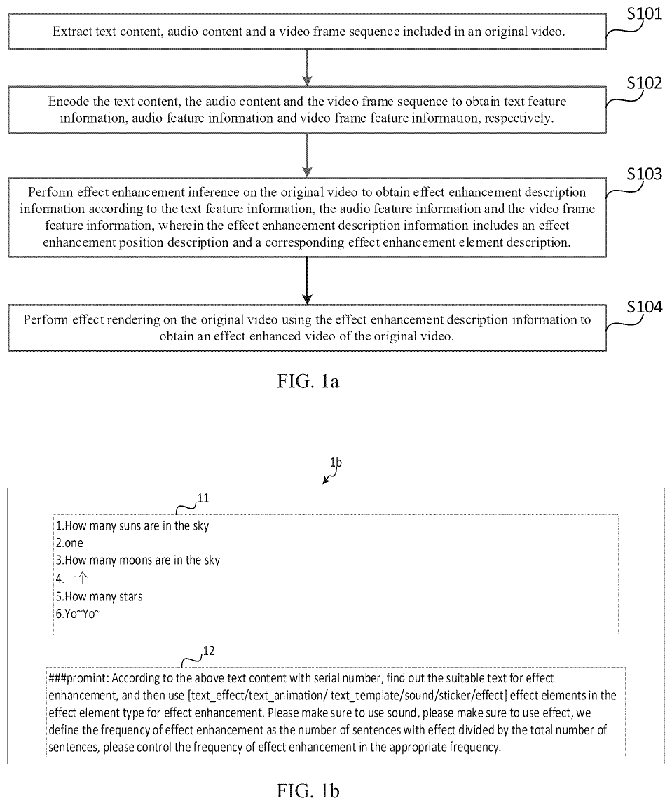

On such basis, embodiments of the present disclosure provide a video processing method. FIG. 1a is a schematic flow diagram of a video processing method provided by embodiment of the present disclosure. The embodiments of the present disclosure are applicable to a case of performing effect enhancement on a video. The method may be executed by a video processing apparatus, which may be implemented in a form of software and/or hardware, and optionally implemented by an electronic device, and the electronic device is preferably a mobile terminal, a desktop, a laptop computer, a server, etc.

It should be known that an execution carrier of a video processing method provided by embodiments of the present may be integrated as a functional plug-in in a video-related entertainment interactive application, or may be directly installed as an application software on the electronic device.

As shown in FIG. la, the video processing method provided by the embodiments of the present disclosure may include:
S101, extract text content, audio content and a video frame sequence included in an original video.

It should be noted that a scenario in which the video processing method provided by the embodiments is applied may be to trigger a video processing icon presented on a desktop of the electronic device, thereby enabling the video processing function provided by the embodiments. It may also be to trigger a video processing function control in a certain application software, thereby enabling the video processing function provided by the embodiments.

In the embodiments, the original video may be considered as a video material to be processed with effect enhancement that is selected after the video processing operation is started. Generally, the original video includes text content (such as subtitles, a video title, etc.), the audio content (such as dubbing, background music, or original sound of characters and animals contained in the video, etc.) and video frame content (it can be known that a video may be divided into a plurality of video frames in unit of frame). This step may be to extract, from the original video, the text content, audio content, and video frame sequence including each video frame.

It can be known that the text content, the audio content and the video frame sequence may be extracted according to a playback order of the video in the embodiments. When the original video does not include the text content or the audio content, such information may be set to null. In the present embodiments, the text content for subsequent effect enhancement inference includes not only the text content contained in the video, but also additional description content for controlling an effect enhancement inference frequency and an effect type.
S102, encode the text content, the audio content and the video frame sequence to obtain text feature information, audio feature information and video frame feature information, respectively.

In the embodiments, the extracted text content, the audio content and the video frame sequence may be semantically encoded through this step. One implementation of encoding may use a text encoder to semantically encode the text content, and determine encoded information that is output as the text feature information. It may also use an audio encoder to encode the audio content, and determine encoded information that is output as the audio feature information. It may also use a visual encoder to encode the video frame sequence, and determine encoded information that is output as the video frame feature information.

The text feature information, the audio feature information and the video frame feature information that are obtained may all be represented in a form of vector.
S103, perform effect enhancement inference on the original video to obtain effect enhancement description information according to the text feature information, the audio feature information and the video frame feature information, where the effect enhancement description information includes an effect enhancement position description and a corresponding effect enhancement element description.

In the embodiments, whether the text feature information, the audio feature information, or the video frame feature information may all be regarded as information that may describe characteristics of the content included in the original video. It can be known that when it is expected to add effects with higher adaptability and more types to the original video, the characteristics of the original video itself need to be understood first, such as whether the original video belongs to a category of advertising, scenery or character introduction, or whether a tone of the original video is funny or sad, etc.

In order to more fully understand the characteristics of the original video in the embodiments, the original video is analyzed from three dimensions: text content, audio content, and video frame content. From a perspective of a computer device, the feature information formed after encoding the text content, the audio content and the video frame sequence may be regarded as information that may be used by the computer device to perform inference analysis on the original video.

In the embodiments, a certain algorithm model may be used to implement inference analysis for the text feature information, the audio feature information, and the video frame feature information, so as to infer and analyze which positions in the original video are suitable for adding effects, and analyze what types of effects are suitable for adding and names of the added effects. The algorithm model may be a large language model with effect inference ability.

Continuing with the above description, the positions of added effect enhancement elements, the types of added effect enhancement elements, and the names of effects inferred may be regarded as an inference analysis result, and these effect enhancement elements to be added to the original video may be recorded as the effect enhancement elements. In the embodiments, the inference analysis result may be described in a preset format. The obtained description information may be summarized as an effect enhancement position description that represents the positions of the effect enhancement elements in the original video, and an effect enhancement element description (such as element type and element name) that represents which effect enhancement elements are specifically enhanced in the original video. The above description information may be recorded as the effect enhancement description information of the embodiments with respect to the original video.

It may be optimized to define that the effect enhancement elements include a text effect enhancement element, an audio effect enhancement element, and a video effect enhancement element. Specifically, more comprehensive and accurate effect enhancement inference may be achieved for the original video through the text feature information, the audio feature information and the video frame feature information. As a result, the inferred types of effects that may be enhanced in the original video are also relatively more comprehensive, which may include text effect elements, such as adding fancy characters or enhancing a font of existing text by bolding or adding color, and the like, or may include audio effect elements, such as adding some prompts, funny or sad sound effects, and the like, or may also include visual effects, such as filter color adjustment, transitions and other visual enhancements.
S104, perform effect rendering on the original video using the effect enhancement description information to obtain an effect enhanced video of the original video.

In the embodiments, by analyzing the effect enhancement description information, it is possible to determine which type of effect element may be added to the original video, and also determine the specific name, specific position of addition, or specific object of addition, etc. This step may construct effect rendering channels of different effect types, and then based on an analysis of the effect enhancement description information, render effects corresponding to the effect element names on the effect rendering channels of the matching effect types, and merge rendered effects with the original video to obtain a final effect enhanced video. The effect enhanced video determined in the embodiments includes text effects, audio effects and visual effects, which further enriches the types of effects displayed.

From a perspective of visualization, an implementation of the video processing method provided by the embodiments may be described as receiving a submitted or selected original video, and then processing the original video using the video processing method provided by the embodiments, and thus displaying a video preview window. The effect enhanced video associated with the original video may be played in the video preview window, and through the played effect enhanced video, it can be seen that the video processing method provided by the embodiments may perform effect enhancement, which is more suitable for the original video content, on the original video in terms of text, audio, and vision.

In the video processing method provided by the embodiment of the present disclosure, audio feature information and video frame feature information are added to participate in the effect enhancement inference of the original video. The added audio feature information and video frame effect information enable more detailed features in the original video to be added to the implementation of the effect enhancement inference, which is equivalent to enriching inferable contents on which the effect enhancement inference relies, thereby ensuring that inferred enhanced effects better match with the original video. In the meantime, compared with the existing method of only performing simple or single effect enhancement on the original video, the technical solution may also ensure that the inferred enhanced effects cover a wider range of effect types through the added audio feature information and video frame effect information, thereby improving the visual and auditory experience that may be brought by the video after effect enhancement packaging.

It should be understood that in the embodiments, the algorithm model is used to implement the effect enhancement inference of the original video, where the text feature information, the audio feature information and the video frame feature information may be used as input information required by the algorithm model for the effect enhancement inference. In an existing implementation of manual addition, it takes up too much manpower cost, however for the computer device, it does not require too much computing power and space to process automatic enhancement of effects.

In the embodiments, in order to implement the automatic enhancement of effects, an algorithm model that performs inference analysis on various feature information associated with the video is required for implementation. For the algorithm model, it also needs to take up more computing resources and space to undertake the inference analysis of the audio feature information and the video frame feature information. In this case, the computing pressure of the algorithm model and the processing time spent will increase accordingly. How to ensure that the algorithm model may output more effective effect enhancement description information without increasing the computing pressure and processing time too much has also become a problem that needs to be solved by the video processing method of the embodiments.

On such basis, as a first optional embodiment of the present embodiments, on the basis of the above embodiments, for the execution of performing effect enhancement inference on the original video to obtain effect enhancement description information according to the text feature information, the audio feature information and the video frame feature information, the following steps are given to solve the problem that may be encountered in the video effect enhancement processing of the embodiments, which may specifically include the following steps:
a) performing alignment and compression processing on the text feature information, the audio feature information and the video frame feature information to obtain target feature information.

In the first optional embodiment, in order to reduce the computing resources occupied and the computing time when the inference analysis is performed on the text feature information, the audio feature information and the video frame feature information, before the algorithm model is used for inference analysis, the text feature information, the audio feature information and the video frame feature information may be processed through this step, and the processing performed may specifically include alignment processing and compression processing.

In the embodiment, the text feature information, the audio feature information and the video frame feature information are all represented in a time sequence of video playback. Therefore, for the alignment processing, the three feature information may be aligned in time dimension so that the three feature information of a same time period or a same time point may be input into the algorithm model in parallel; in addition, an input of the algorithm model is often input in a unified feature space; and similarly for the alignment processing, the three feature information may also be aligned in information representation. For time alignment, it may set a reference timeline, and align the three feature information through the reference timeline; for the alignment of the feature information expression form, it may set a reference feature space, and convert the three feature information into the form under the reference feature space to implement alignment.

In addition, it can be understood that the three types of feature information as input information of the algorithm model have a large scale, especially the video frame feature information, which is equivalent to that each video frame in the original video corresponds to the video frame feature information and participates in the inference analysis. On such basis, in the first optional embodiment, compression processing may also be performed on the feature information, where the compression processing may be implemented by performing dimensionality augmentation and reduction processing on the feature information.

In this embodiment, the feature information obtained after alignment and compression processing may be determined as target feature information, and the three feature information may correspond to one target feature information respectively.

As an implementation mode thereof, in the first optional embodiment, the following steps may be further specified to perform alignment and compression processing on the text feature information, the audio feature information, and the video frame feature information to obtain target feature information:
a11) perform time alignment on the text feature information, the audio feature information and the video frame feature information and mapping the text feature information, the audio feature information and the video frame feature information to a same feature space, and perform feature alignment, to obtain aligned feature information.

In the embodiment, the time alignment of three feature information may be implemented through this step. The three feature information after the time alignment may be mapped to the same feature space again to align the feature representation form in the same feature space, thereby obtaining the corresponding aligned feature information.
a12) perform dimensionality augmentation and dimensionality reduction sampling processing on the aligned feature information according to a preset feature compression target to obtain compressed feature information.

In the embodiment, in order to avoid excessive feature compression, the feature compression target may be preset as a compression constraint condition, under which the compressed feature information may be obtained by feature sampling in the form of dimensionality augmentation and dimensionality reduction.
a13) perform pooling processing on the compressed feature information to obtain the target feature information.

In the embodiment, the compressed feature information may also be compressed again through pooling processing in this step to obtain final target feature information. It should be noted that the three types of feature information may be regarded to be compressed and the target feature information may be obtained respectively. Alternatively, the aligned text feature information and audio feature information may be directly referred to as the corresponding target feature information, and only the video frame feature information is compressed and the video frame feature information after secondary compression is recorded as the corresponding target feature information.

The above technical solution of the embodiment provides a technical implementation of performing alignment and compression processing on feature information before the effect enhancement inference. Through the above technical solution, effective feature information with small computing resources and space occupied may be obtained to participate in the subsequent effect enhancement inference analysis.
b1) input the target feature information as input information into an effect enhancement inference model to obtain the effect enhancement description information.

In the embodiment, the target feature information corresponding to the three dimensions of text, audio and video frame may be obtained through the above step a1). In this step, the target feature information may be used as input information of the algorithm model for effect enhancement inference. The target feature information may be divided into a plurality of semantic blocks, which are input into the algorithm model as input information in the form of semantic blocks to implement effect enhancement inference, and obtain the effect enhancement description information output by the algorithm model.

In the embodiment, the algorithm model used may be an effect enhancement inference model formed by pre-training, and the effect enhancement inference model may be obtained by training and learning the constructed large language model.

Specifically, this embodiment may optimize the effect enhancement inference model by training a pre-constructed large language model based on a set sample training set; the sample training set includes at least one binary sample information group, and the binary sample information group includes sample input information of a sample video that is associated and a model learning target that is preset; the sample input information is sample content formed from three dimensions of text, audio and video frame with respect to the sample video; and the model learning target is expected effect description information of an expected enhancement effect of the sample video.

It can be known that sample data for model training often needs to include sample input information for training and real output information compared with the output content of the model, and the sample input information and the real output information included are equivalent to forming a sample relationship group. In the meantime, it can also be known that the sample set participating in model training and learning is often a sample set, which includes a certain scale of sample relationship group.

Therefore, in the embodiment, it may be considered that the binary sample information group included in the sample training set are all used for training and learning of the large language model, and one binary sample information group may be used to view one training sample, and the sample input information included in the binary sample information group is used to input into the large language model to be trained, and the sample input information may specifically be the sample content extracted from the three dimensions of text, audio and video frame of the sample video. In the meantime, the model learning target included in the binary sample information group may be considered as the effect enhancement description information expected to be obtained when the sample video is subjected to effect enhancement processing, and the effect enhancement description information may be recorded as the expected effect description information.

On the basis of the above optimization, the sample content may be optimized to include: sample text content, sample audio content and sample video frame content; and the sample text content may also be optimized to include control description information for controlling a frequency of effect enhancement and a type of enhanced effect.

It can be known that one binary sample information group corresponds to one sample video, and the sample text content, the sample audio content and the sample video frame content may all be extracted from the sample video. In the meantime, the sample text content is also added with the control description information for controlling the frequency of effect enhancement and the type of enhanced effect, so as to be used for the construction of data involved in the inference analysis of the sample input information by the large language model.

Exemplarily, FIG. 1b is a schematic diagram of a sample text content in a video processing method provided by embodiments of the present disclosure. As shown in FIG. 1b, with respect to one sample video, specific description of the corresponding sample text content may include a content description segment 11 of the text content and a control description segment 12 of the text content included in the sample video.

On the basis of the above optimization, the expected effect description information may be optimized to include intermediate inference description information for providing intermediate inference to an effect element expected to be enhanced, and further include at least one piece of effect trigger description information that triggers enhancement of the effect element; the effect trigger description information may be optimized to include an index number and at least one effect trigger description entry; and the effect trigger description entry may be optimized to include a trigger semantic block, an effect element type corresponding to a trigger and an effect element name corresponding to the trigger.

In the embodiment, in order to facilitate the large language model completing the effect enhancement inference under a current iteration with respect to the input sample input information; the intermediate inference description information may be added to the expected effect description information, and the intermediate inference description information may be implemented in a form of a large model thinking chain, and the intermediate inference description information may provide intermediate inference information to the large language model.

Continuing with the above description, it is expected that the effect description information further includes effect description information that is compared with the output information output by the current iteration of the large language model. Considering that the effect description information is used for triggering the addition of effect elements in the video, in the embodiment, the effect description information is recorded as effect trigger description information for triggering effect elements to perform video enhancement.

In the embodiment, with respect to a sample video, its corresponding effect trigger description information often includes a plurality of effect trigger description information, each effect trigger description information may be regarded as a sample description sentence. The effect trigger description information includes an index number for distinguishing from other effect trigger description information, and an effect trigger description entry constituting a sample description sentence. The number of effect trigger description entries included is at least one.

Exemplarily, a piece of effect trigger description information may be represented in the following manner:
{index number}.<trigger semantic block 1>-{effect element type}-{effect element name}<trigger semantic block 2>-{effect element type}-{effect element name} . . . <trigger semantic block m>-{effect element type}-{effect element name}.

In the embodiment, the trigger semantic block included in the effect trigger description entry may be a trigger word, position information of the trigger word, or a set special field, such as an interval field between two effect trigger description information, or may be a certain region in the video frame sample content or a certain text description information in the text sample content.

Continuing with the above description, the trigger semantic block is mainly used for describing different triggers. In an effect trigger description entry, by setting the trigger semantic block, a matching effect element may also be set for a corresponding trigger, and attribute information of the effect element may be described by the effect element type and the effect element name.

Exemplarily, FIG. 1c is a schematic diagram of an expected effect description information in a video processing method provided by embodiments of the present disclosure. As shown in FIG. 1c, the expected effect description information 13 may be regarded as a sample learning target content with respect to the sample text content shown in FIG. 1b. The expected effect description information 13 includes an intermediate inference description information segment 14 and an effect trigger description information segment 15, and the effect trigger description information segment 15 includes a certain number of effect trigger description information, and each effect trigger description information includes an index number and a plurality of effect trigger description entries.

The above technical solution of the embodiment provides determination and implementation of the effect enhancement description information, taking into account a problem of feature information misalignment caused by multi-dimensional feature information, and the large computing resources and space occupied. Therefore, the feature information is first aligned and compressed to ensure rationality of the input information for effect enhancement inference. Then, the effect enhancement inference model formed by the large language model training is used for determining the effect enhancement description information. This embodiment implements a directional training of the large language model by setting a special sample training set for the large language model, thereby ensuring that the obtained effect enhancement description information may render effect elements that better match the original video, and further ensuring effective improvement of the effects at the audio and visual levels.

As a second optional embodiment of the present embodiments, based on the above optimization, the effect rendering of the original video may be performed using the effect enhancement description information, to obtain the effect enhanced video of the original video, which is specifically optimized into the following steps:
a2) parse the effect enhancement description information to obtain an effect element name of an effect to be enhanced, an effect element type of the effect to be enhanced and effect enhancement position of the effect to be enhanced.

In the embodiment, the effect enhancement description information output by the algorithm model with respect to the original video includes detailed description information of the effect to be enhanced, such as the effect element name, effect element type and effect enhancement position of the effect to be enhanced.
b2) construct an effect rendering channel with respect to respective effect element types, and render the effect to be enhanced invoked by the effect element name to a corresponding effect rendering channel, where a rendering position of the effect to be enhanced presented on the effect rendering channel is determined based on a corresponding effect enhancement position.

In the embodiment, the effect rendering of the original video may be implemented by constructing an effect rendering channel, and the effect rendering channel is associated with an effect type of the effect to be rendered. In this step, the corresponding effect rendering channel may be constructed according to the effect element type, and the effect element associated with the effect element name may be invoked on the effect rendering channel corresponding to each effect type, where the effect element may be recorded as the effect to be enhanced. Moreover, in the rendering implementation, a rendering position of the effect to be enhanced on the effect rendering channel may be determined according to the effect enhancement position corresponding to the effect to be enhanced in the original video.
c2) merge an effect rendered on the effect rendering channel with the original video to obtain the effect enhanced video of the original video.

The above technical solution of the embodiment provides a specific description of implementing effect rendering of the original video. Through this technical solution, an effect enhanced video with better audio and visual effects may be obtained, thereby improving user experience of the effect enhanced video.

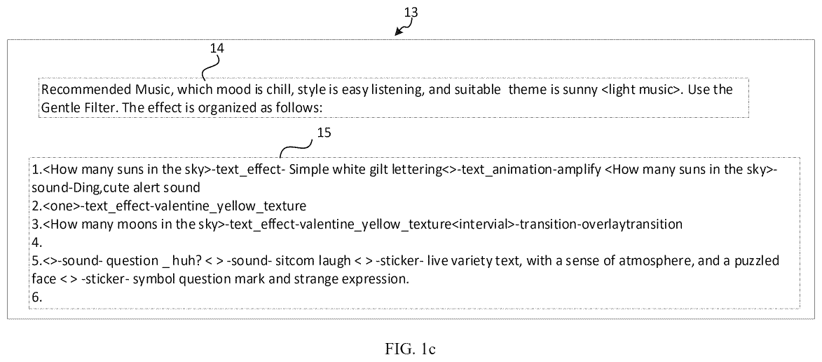

It should be noted that, in order to better understand the implementation process of the video processing method provided by the embodiments, FIG. 2 is a schematic diagram of an example implementation for a video processing method provided by embodiments of the present disclosure. As shown in FIG. 2, the execution of the video processing method may first extract content of an original video 21 to obtain text content 221, audio content 222 and video frame sequence 223 included in an information extraction frame 22, where the text content 211 includes not only the original video text extracted from the original video, but also control description information for effect enhancement inference.

Afterwards, the text content 221, the audio content 222 and the video frame sequence 223 may be encoded respectively by a text encoder 231, an audio encoder 232 and a visual encoder 233 included in an encoding processing layer 23.

Then, the obtained encoding results are aligned and compressed to form a certain number of multimodal semantic blocks in an information output layer 24.

In another step, the multimodal semantic blocks in the information output layer 24 is used as input information of an effect enhancement inference model 25. After the inference analysis of the effect enhancement inference model 25, effect enhancement description information 26 that is output is obtained.

The effect enhancement description information 26 may be used for effect rendering of the original video, where the rendered effect element may be presented on the effect rendering channel corresponding to a specific effect element type.

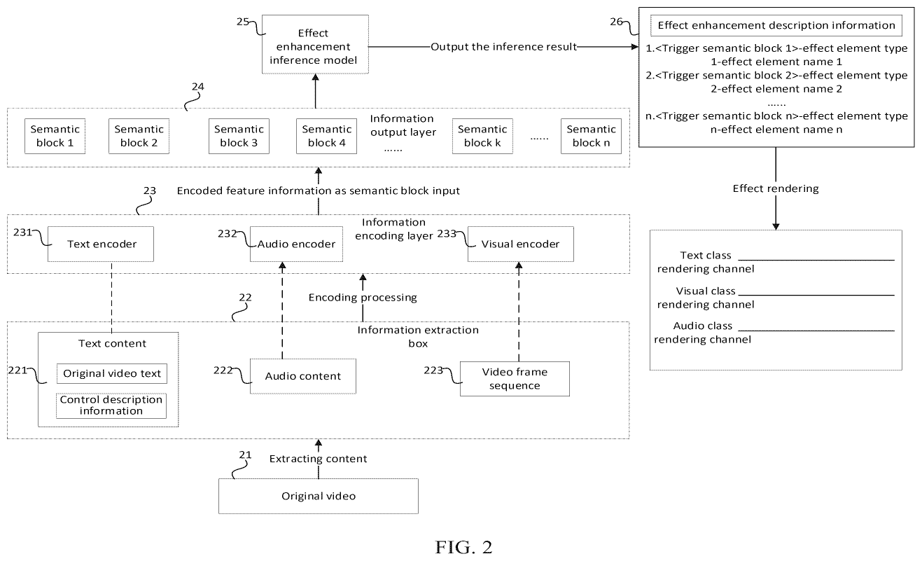

FIG. 3 is a structural schematic diagram of a video processing apparatus provided by embodiments of the present disclosure. As shown in FIG. 3, the apparatus may include: an information extracting module 31, an encoding processing module 32, an information determining module 33 and an effect rendering module 34.

The information extracting module 31 is configured to extract text content, audio content and a video frame sequence included in an original video;

The encoding processing module 32 is configured to encode the text content, the audio content and the video frame sequence to obtain text feature information, audio feature information and video frame feature information, respectively;

The information determining module 33 is configured to perform effect enhancement inference on the original video to obtain effect enhancement description information according to the text feature information, the audio feature information and the video frame feature information, where the effect enhancement description information includes an effect enhancement position description and a corresponding effect enhancement element description; and

The effect rendering module 34 is configured to perform effect rendering on the original video using the effect enhancement description information to obtain an effect enhanced video of the original video.

In the video processing apparatus provided by the embodiments of the present disclosure, audio feature information and video frame feature information are added to participate in the effect enhancement inference of the original video, and the added audio feature information and video frame feature information enable more detailed features in the original video to be added to the implementation of the effect enhancement inference, which is equivalent to enriching inferable contents on which the effect enhancement inference relies, thereby ensuring that inferred enhanced effects better match with the original video. In the meantime, compared with the existing method of manually performing simple or single effect enhancement on the original video, the technical solutions may also ensure that the inferred enhanced effects cover a wider range of effect types through the added audio feature information and video frame effect information, thereby improving visual and auditory experience that may be brought by the video after effect enhancement packaging.

Further, the information determining module 33 may specifically include:
a feature processing unit, which is configured to perform alignment and compression processing on the text feature information, the audio feature information and the video frame feature information to obtain target feature information; and
a model inferencing unit, which is input the target feature information as input information into an effect enhancement inference model to obtain the effect enhancement description information.

Further, the feature processing unit may specifically include:
performing time alignment on the text feature information, the audio feature information and the video frame feature information and mapping the text feature information, the audio feature information and the video frame feature information to a same feature space, and performing feature alignment, to obtain aligned feature information;
performing dimensionality augmentation and dimensionality reduction sampling processing on the aligned feature information according to a preset feature compression target to obtain compressed feature information; and
performing pooling processing on the compressed feature information to obtain the target feature information.

Further, the effect enhancement inference model is obtained by training a pre-constructed large language model based on a sample training set that is preset;
the sample training set includes at least one binary sample information group, and the binary sample information group includes sample input information of a sample video that is associated and a model learning target that is preset;
the sample input information is sample content formed from three dimensions of text, audio and video frame with respect to the sample video; and
the model learning target is expected effect description information of an expected enhancement effect of the sample video.

Further, the sample content includes: sample text content, sample audio content and sample video frame content; and
the sample text content further includes control description information for controlling a frequency of effect enhancement and a type of enhanced effect.

Further, the expected effect description information includes intermediate inference description information for providing intermediate inference to an effect element expected to be enhanced, and further includes at least one piece of effect trigger description information that triggers enhancement of the effect element;
the effect trigger description information includes an index number and at least one effect trigger description entry; and
the effect trigger description entry includes a trigger semantic block, an effect element type corresponding to a trigger and an effect element name corresponding to the trigger.

Further, the effect rendering module 34 may specifically be configured to:
parse the effect enhancement description information to obtain an effect element name of an effect to be enhanced, an effect element type of the effect to be enhanced and effect enhancement position of the effect to be enhanced;
construct an effect rendering channel with respect to respective effect element types, and render the effect to be enhanced invoked by the effect element name to a corresponding effect rendering channel, where a rendering position of the effect to be enhanced presented on the effect rendering channel is determined based on a corresponding effect enhancement position; and
merge an effect rendered on the effect rendering channel with the original video to obtain the effect enhanced video of the original video.

The video processing apparatus provided by the embodiments of the present disclosure may execute the video processing method provided in any embodiment of the present disclosure, with the corresponding functional modules and beneficial effects of the execution method.

It is worth noting that the various units and modules included in the above device are only divided according to functional logic, but are not limited to the above division, as long as the corresponding functions can be realized; furthermore, the specific names of the various functional units are only for the purpose of facilitating differentiation from each other, and are not used to limit the scope of protection of the embodiments of the present disclosure.

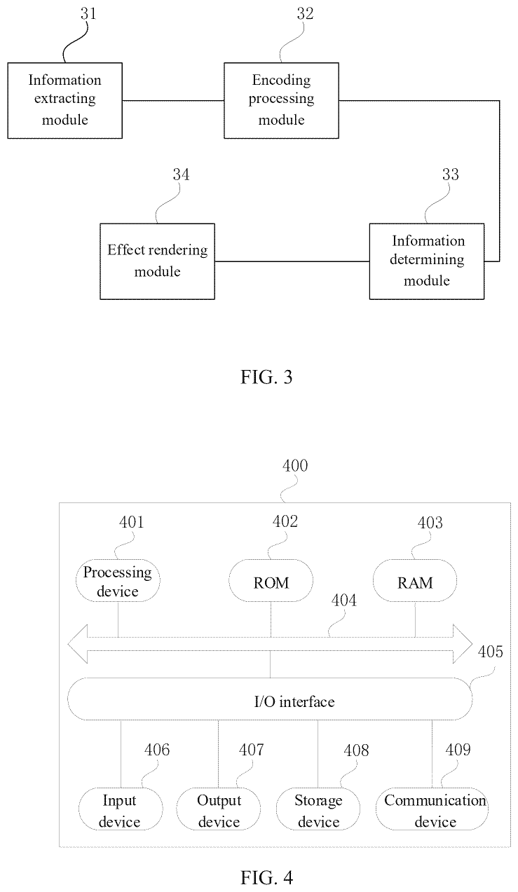

FIG. 4 is a structural schematic diagram of an electronic device provided by embodiments of the present disclosure. Reference is made to FIG. 4 below, which is a structural schematic diagram of an electronic device 400 suitable for implementing the embodiments of the present disclosure. The terminal device in the embodiment of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 4 is merely an example, and should not pose any limitation to the functions and the range of use of the embodiments of the present disclosure.

As shown in FIG. 4, the electronic device 400 may include a processing apparatus (e.g., a central processing unit, a graphics processing unit, etc.) 401 that may perform various appropriate actions and processes according to a program stored in a read-only memory (ROM) 402 or a program loaded from a storage apparatus 408 into a random-access memory (RAM) 403. The RAM 403 further stores various programs and data required for the operation of the electronic device 400. The processing apparatus 401, the ROM 402, and the RAM 403 are connected to each other through a bus 404. An input/output (I/O) interface 405 is also connected to the bus 404.

Generally, the following apparatuses may be connected to the I/O interface 405: an input apparatus 406 including, for example, a touchscreen, a touchpad, a keyboard, a mouse, a camera, a microphone, an accelerometer, a gyroscope, or the like; an output apparatus 407 including, for example, a liquid crystal display (LCD), a speaker, a vibrator, or the like; a storage apparatus 408 including, for example, a magnetic tape, a hard disk, or the like; and a communication apparatus 409. The communication apparatus 409 may allow the electronic device 400 to perform wireless or wired communication with other devices to exchange data. Although FIG. 4 shows the electronic device 400 having various apparatuses, it should be understood that it is not required to implement or have all of the illustrated apparatuses. More or fewer apparatuses may alternatively be implemented or provided.

In particular, according to an embodiment of the present disclosure, the process described above with reference to the flowchart can be implemented as a computer software program. For example, an embodiment of the present disclosure includes a computer program product, which includes a computer program carried on a non-transitory computer-readable medium, where the computer program includes program codes for executing the method shown in the flowchart. In such an embodiment, the computer program can be downloaded and installed from a network through the communication apparatus 409, or installed from the storage apparatus 408, or installed from the ROM 402. When the computer program is executed by the processing apparatus 401, the above functions defined in the method of the embodiments of the present disclosure are executed.

The names of the messages or information interacted with between the plurality of apparatuses of the embodiments of the present disclosure are used for illustrative purposes only and are not intended to place limitations on the scope of those messages or information.

The electronic device provided by the embodiments of the present disclosure belongs to the same disclosure concept as the video processing method provided by the above embodiments, and technical details not exhaustively described in the present embodiments can be found in the above embodiments, and the present embodiments have the same beneficial effects as the above embodiments.

Embodiments of the present disclosure provide a computer storage medium having a computer program stored thereon, which the program when executed by a processor implements the video processing method provided by the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above computer-readable medium may be included in the above electronic device; or may also exist alone without being assembled into the electronic device.

The above computer-readable medium carries one or more programs. When the one or more programs are executed by the electronic device, the electronic device is caused to: extract text content, audio content and a video frame sequence included in an original video; encode the text content, the audio content and the video frame sequence to obtain text feature information, audio feature information and video frame feature information, respectively; perform effect enhancement inference on the original video to obtain effect enhancement description information according to the text feature information, the audio feature information and the video frame feature information, where the effect enhancement description information includes an effect enhancement position description and a corresponding effect enhancement element description; and perform effect rendering on the original video using the effect enhancement description information to obtain an effect enhanced video of the original video.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard parts (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A video processing method, comprising:
extracting text content, audio content and a video frame sequence comprised in an original video;
encoding the text content, the audio content and the video frame sequence to obtain text feature information, audio feature information and video frame feature information, respectively;
performing effect enhancement inference on the original video to obtain effect enhancement description information according to the text feature information, the audio feature information and the video frame feature information, wherein the effect enhancement description information comprises an effect enhancement position description and a corresponding effect enhancement element description; and
performing effect rendering on the original video using the effect enhancement description information to obtain an effect enhanced video of the original video.

2. The method according to claim 1, wherein the performing effect enhancement inference on the original video to obtain effect enhancement description information according to the text feature information, the audio feature information and the video frame feature information, comprises:
performing alignment and compression processing on the text feature information, the audio feature information and the video frame feature information to obtain target feature information; and
inputting the target feature information as input information into an effect enhancement inference model to obtain the effect enhancement description information.

3. The method according to claim 2, wherein the performing alignment and compression processing on the text feature information, the audio feature information and the video frame feature information to obtain target feature information, comprises:
performing time alignment on the text feature information, the audio feature information and the video frame feature information and mapping the text feature information, the audio feature information and the video frame feature information to a same feature space, and performing feature alignment, to obtain aligned feature information;
performing dimensionality augmentation and dimensionality reduction sampling processing on the aligned feature information according to a preset feature compression target to obtain compressed feature information; and
performing pooling processing on the compressed feature information to obtain the target feature information.

4. The method according to claim 2, wherein the effect enhancement inference model is obtained by training a pre-constructed large language model based on a sample training set that is preset;
the sample training set comprises at least one binary sample information group, and the binary sample information group comprises sample input information of a sample video that is associated and a model learning target that is preset;
the sample input information is sample content formed from three dimensions of text, audio and video frame with respect to the sample video; and
the model learning target is expected effect description information of an expected enhancement effect of the sample video.

5. The method according to claim 4, wherein the sample content comprises: sample text content, sample audio content and sample video frame content; and
the sample text content further comprises control description information for controlling a frequency of effect enhancement and a type of enhanced effect.

6. The method according to claim 4, wherein the expected effect description information comprises intermediate inference description information for providing intermediate inference to an effect element expected to be enhanced, and further comprises at least one piece of effect trigger description information that triggers enhancement of the effect element;
the effect trigger description information comprises an index number and at least one effect trigger description entry; and
the effect trigger description entry comprises a trigger semantic block, an effect element type corresponding to a trigger and an effect element name corresponding to the trigger.

7. The method according to claim 1, wherein the performing effect rendering on the original video using the effect enhancement description information to obtain an effect enhanced video of the original video, comprises:
parsing the effect enhancement description information to obtain an effect element name of an effect to be enhanced, an effect element type of the effect to be enhanced and effect enhancement position of the effect to be enhanced;
constructing an effect rendering channel with respect to respective effect element types, and rendering the effect to be enhanced invoked by the effect element name to a corresponding effect rendering channel, wherein a rendering position of the effect to be enhanced presented on the effect rendering channel is determined based on a corresponding effect enhancement position; and
merging an effect rendered on the effect rendering channel with the original video to obtain the effect enhanced video of the original video.

8. An electronic device, comprising:
at least one processor; and
a memory configured to store one or more programs, wherein
the one or more programs, when executed by the at least one processor, cause the at least one processor to implement a video processing method, and the method comprises:
extracting text content, audio content and a video frame sequence comprised in an original video;
encoding the text content, the audio content and the video frame sequence to obtain text feature information, audio feature information and video frame feature information, respectively;
performing effect enhancement inference on the original video to obtain effect enhancement description information according to the text feature information, the audio feature information and the video frame feature information, wherein the effect enhancement description information comprises an effect enhancement position description and a corresponding effect enhancement element description; and
performing effect rendering on the original video using the effect enhancement description information to obtain an effect enhanced video of the original video.

9. The electronic device according to claim 8, wherein the performing effect enhancement inference on the original video to obtain effect enhancement description information according to the text feature information, the audio feature information and the video frame feature information, comprises:
performing alignment and compression processing on the text feature information, the audio feature information and the video frame feature information to obtain target feature information; and
inputting the target feature information as input information into an effect enhancement inference model to obtain the effect enhancement description information.

10. The electronic device according to claim 9, wherein the performing alignment and compression processing on the text feature information, the audio feature information and the video frame feature information to obtain target feature information, comprises:
performing time alignment on the text feature information, the audio feature information and the video frame feature information and mapping the text feature information, the audio feature information and the video frame feature information to a same feature space, and performing feature alignment, to obtain aligned feature information;
performing dimensionality augmentation and dimensionality reduction sampling processing on the aligned feature information according to a preset feature compression target to obtain compressed feature information; and
performing pooling processing on the compressed feature information to obtain the target feature information.

11. The electronic device according to claim 9, wherein the effect enhancement inference model is obtained by training a pre-constructed large language model based on a sample training set that is preset;
the sample training set comprises at least one binary sample information group, and the binary sample information group comprises sample input information of a sample video that is associated and a model learning target that is preset;
the sample input information is sample content formed from three dimensions of text, audio and video frame with respect to the sample video; and
the model learning target is expected effect description information of an expected enhancement effect of the sample video.

12. The electronic device according to claim 11, wherein the sample content comprises: sample text content, sample audio content and sample video frame content; and
the sample text content further comprises control description information for controlling a frequency of effect enhancement and a type of enhanced effect.

13. The electronic device according to claim 11, wherein the expected effect description information comprises intermediate inference description information for providing intermediate inference to an effect element expected to be enhanced, and further comprises at least one piece of effect trigger description information that triggers enhancement of the effect element;
the effect trigger description information comprises an index number and at least one effect trigger description entry; and
the effect trigger description entry comprises a trigger semantic block, an effect element type corresponding to a trigger and an effect element name corresponding to the trigger.

14. The electronic device according to claim 8, wherein the performing effect rendering on the original video using the effect enhancement description information to obtain an effect enhanced video of the original video, comprises:
parsing the effect enhancement description information to obtain an effect element name of an effect to be enhanced, an effect element type of the effect to be enhanced and effect enhancement position of the effect to be enhanced;
constructing an effect rendering channel with respect to respective effect element types, and rendering the effect to be enhanced invoked by the effect element name to a corresponding effect rendering channel, wherein a rendering position of the effect to be enhanced presented on the effect rendering channel is determined based on a corresponding effect enhancement position; and
merging an effect rendered on the effect rendering channel with the original video to obtain the effect enhanced video of the original video.

15. A non-transitory computer-readable storage medium having a computer program stored thereon, wherein the program, when executed by a processor, implements a video processing method, and the method comprises:
extracting text content, audio content and a video frame sequence comprised in an original video;
encoding the text content, the audio content and the video frame sequence to obtain text feature information, audio feature information and video frame feature information, respectively;
performing effect enhancement inference on the original video to obtain effect enhancement description information according to the text feature information, the audio feature information and the video frame feature information, wherein the effect enhancement description information comprises an effect enhancement position description and a corresponding effect enhancement element description; and
performing effect rendering on the original video using the effect enhancement description information to obtain an effect enhanced video of the original video.

16. The non-transitory computer-readable storage medium according to claim 15, wherein the performing effect enhancement inference on the original video to obtain effect enhancement description information according to the text feature information, the audio feature information and the video frame feature information, comprises:
performing alignment and compression processing on the text feature information, the audio feature information and the video frame feature information to obtain target feature information; and
inputting the target feature information as input information into an effect enhancement inference model to obtain the effect enhancement description information.

17. The non-transitory computer-readable storage medium according to claim 16, wherein the performing alignment and compression processing on the text feature information, the audio feature information and the video frame feature information to obtain target feature information, comprises:
performing time alignment on the text feature information, the audio feature information and the video frame feature information and mapping the text feature information, the audio feature information and the video frame feature information to a same feature space, and performing feature alignment, to obtain aligned feature information;
performing dimensionality augmentation and dimensionality reduction sampling processing on the aligned feature information according to a preset feature compression target to obtain compressed feature information; and
performing pooling processing on the compressed feature information to obtain the target feature information.

18. The non-transitory computer-readable storage medium according to claim 16, wherein the effect enhancement inference model is obtained by training a pre-constructed large language model based on a sample training set that is preset;
the sample training set comprises at least one binary sample information group, and the binary sample information group comprises sample input information of a sample video that is associated and a model learning target that is preset;
the sample input information is sample content formed from three dimensions of text, audio and video frame with respect to the sample video; and
the model learning target is expected effect description information of an expected enhancement effect of the sample video.

19. The non-transitory computer-readable storage medium according to claim 18, wherein the sample content comprises: sample text content, sample audio content and sample video frame content; and
the sample text content further comprises control description information for controlling a frequency of effect enhancement and a type of enhanced effect.

20. The non-transitory computer-readable storage medium according to claim 18, wherein the expected effect description information comprises intermediate inference description information for providing intermediate inference to an effect element expected to be enhanced, and further comprises at least one piece of effect trigger description information that triggers enhancement of the effect element;
the effect trigger description information comprises an index number and at least one effect trigger description entry; and
the effect trigger description entry comprises a trigger semantic block, an effect element type corresponding to a trigger and an effect element name corresponding to the trigger.
